(19) United States
(12) Patent Application Publication
(10) Pub. No.: US 2018/0242202 A1
(43) Pub. Date: Aug. 23, 2018

(54) Method and device for accessing service network, and base station

(71) Applicant: ZTE Corporation, Shenzhen, Guangdong (CN)

(72) Inventors: Fangting Zheng, Shenzhen (CN); Zaifeng Zong, Shenzhen (CN); Se Wu, Shenzhen (CN); Yuhong Qiang, Shenzhen (CN)

(21) Appl. No.: 15/570,631

(22) PCT Filed: Dec. 24, 2015
(86) PCT No.: PCT/CN2015/098735

§ 371 Date: Nov. 29, 2017

(30) Foreign Application Priority Data
Apr. 30, 2015 (CN) 201510217815.X

(51) Int. Cl. H04W 36/00; H04W 36/14; H04W 48/18; H04W 36/32; H04W 60/04

(52) U.S. Cl. CPC H04W 36/0016; H04W 36/14; H04W 36/0022; H04W 36/32; H04W 60/04; H04W 48/18

(57) ABSTRACT

Disclosed is a method for accessing a service network, comprising: during the initial access of a terminal, selecting a service network for the terminal according to a specified selection policy; and connecting the terminal to the selected service network, the service network comprising a local network and a global network. The technical solution can shorten user delay.

### TECHNICAL FIELD

The present disclosure relates, but is not limited, to the field of mobile communications, and in particular to a method and device for accessing a service network, and a Base Station (BS).

### BACKGROUND

As shown in FIG. 1, System Architecture Evolution (SAE), which is a project for a next-generation mobile radio network in 3rd Generation Partnership Project (3GPP), may include network elements (NE) as follows.

An Evolved Radio Access Network (E-RAN) may provide radio transmission of increased reliability with an increased uplink and/or downlink rate and a reduced transmission delay. An NE included in the E-RAN may be an Evolved NodeB (eNodeB, eNB), which provides radio resources for access by User Equipment (UE).

A Home Subscriber Server (HSS) may permanently store subscription data of a subscriber.

A Mobility Management Entity (MME) may be a control-plane functionality and a server for temporarily storing subscriber data. An MME may manage and store UE context (such as UE/subscriber identifier, a status of mobility management, a subscriber security parameter, etc.). An MME may allocate a temporary identifier to a subscriber when UE camps in a tracking area or a network is to authenticate the subscriber. An MME may process any non-access-layer messages between UE and the MME. An MME may trigger SAE paging.

A Serving Gateway (GW) may be a subscriber-plane entity for routing subscriber-plane data and terminating downlink data of idle UE. A serving GW may manage and store SAE bearer context of UE, such as an Internet Protocol (IP) bearer service parameter and intra-network routing information. A serving GW may be a subscriber-plane anchor in a 3GPP system. A subscriber may have but one serving GW at a time.

A Packet Data Network (PDN) GW may be responsible for PDN access by UE and allocating an IP address to a subscriber. A PDN GW may be a mobility anchor for a 3GPP access system and a non-3GPP access system. A subscriber may access more than one PDN GW at a time.

A Policy and Charging Rule Functionality (PCRF) may generate, according to service information, subscription information of a subscriber, and configuration information of an operator, a billing rule and a rule for controlling Quality of Service (QoS) associated with delivery of subscriber data. A PCRF may also control establishment and release of a bearer in an access network.

Each of a 2G mobile network to a 4G mobile network may include a Core Network (CN) providing network access to UE. A CN may generally provide high capacity and/or high throughput, aggregate a large number of radio accesses, and adopt localized deployment. Localized deployment of a CN is advantageous in that it requires but simple network construction, unified data planning, and easy maintenance. A downside of localized deployment of a CN is that it leads to a long path of subscriber data, which lowers service experience of a subscriber. Moreover, with localized deployment of a CN, any change may trigger a domino effect. Update and/or replacement of a CN may generate a huge impact.

3GPP may further introduce, in an Evolved Packet Core (EPC), Local IP Access (LIPA) and Selected IP Traffic Offload (SIPTO), as well as a Local GateWay (LGW). Subscriber data may access a service straightforwardly through an LGW, leading to a shorter path of subscriber data. Introduction of an LGW in 4G network architecture is not complete, and may serve as but a supplement to network deployment by an operator. For example, a control-plane flow of UE may still depend on an MME and/or an SGW of localized deployment.

At present, many international organizations start research on a next-generation mobile network. A subscriber end-to-end delay may serve as a vital index of assessment. It is of major importance to reduce a delay of a subscriber by virtue of network architecture.

### SUMMARY

Following is an overview of a subject elaborated herein. The overview is not intended to limit the scope of protection of the claims.

Embodiments herein provide a method and device for accessing a service network, and a Base Station (BS), capable of reducing a delay of a subscriber.

According to an embodiment herein, a method for accessing a service network includes:

at an initial access by UE, selecting, for the UE according a policy, a service network, The service network may include at least one of a local network and a global network; and

allowing the UE to access the selected service network.

The policy may include at least one of: an attribute of the UE, a service requested by the UE, a load of a service network, and a status of the service network.

The attribute of the UE may include at least one of: UE of Internet of Things, UE of Internet of Vehicles, UE for industrial control, telemedicine UE, and UE of low mobility.

The service requested by the UE may include at least one of: a mobile-Internet service, a Virtual Private Network (VPN) service, a service of Internet of Things, a service of Internet of Vehicles, an industrial-control service, a telemedicine service, and a voice service.

The method may further include:

in response to determining that idle UE moves out of an area covered by a serving Base Station (BS), into an area covered by another BS, allowing the idle UE to access a service network of a type identical to that of a service network previously accessed by the idle UE; in response to determining that there is no service network of the type or the service network of the type is unavailable, re-selecting a service network for the idle UE.

The re-selecting a service network for the idle UE may include:

notifying the idle UE to get detached and then reattach to the re-selected service network.

The re-selecting a service network for the idle UE may include:

re-selecting the service network for the idle UE during update of a tracking area.

According to an embodiment herein, a device for accessing a service network includes a selecting module and an access module.

The selecting module is arranged for: at an initial access by UE, selecting, for the UE according a policy, a service network, The service network may include at least one of a local network and a global network.

The access module is arranged for: allowing the UE to access the selected service network.

The policy may include at least one of: an attribute of the UE, a service requested by the UE, a load of a service network, and a status of the service network. The attribute of the UE may include at least one of: UE of Internet of Things, UE of Internet of Vehicles, UE for industrial control, telemedicine UE, and UE of low mobility. The service requested by the UE may include at least one of: a mobile-Internet service, a Virtual Private Network (VPN) service, a service of Internet of Things, a service of Internet of Vehicles, an industrial-control service, a telemedicine service, and a voice service.

The selecting module may be further arranged for: in response to determining that idle UE moves out of an area covered by a serving Base Station (BS), into an area covered by another BS, allowing the idle UE to access a service network of a type identical to that of a service network previously accessed by the idle UE; in response to determining that there is no service network of the type or the service network of the type is unavailable, re-selecting a service network for the idle UE.

The selecting module may be arranged for re-selecting the service network for the idle UE by notifying the idle UE to get detached and then reattach to the re-selected service network.

The selecting module may be arranged for re-selecting the service network for the idle UE during update of a tracking area.

According to an embodiment herein, a Base Station (BS) includes the device for accessing a service network.

Embodiments herein provide a method and device for accessing a service network, and a Base Station (BS), implementing hierarchical deployment of service networks, thereby reducing a delay of a subscriber.

Any other aspect herein may be understood upon viewing the drawings and the detailed description.

### BRIEF DESCRIPTION OF THE DRAWINGS

FIG. 1 is a diagram of architecture of an EPC in related art.

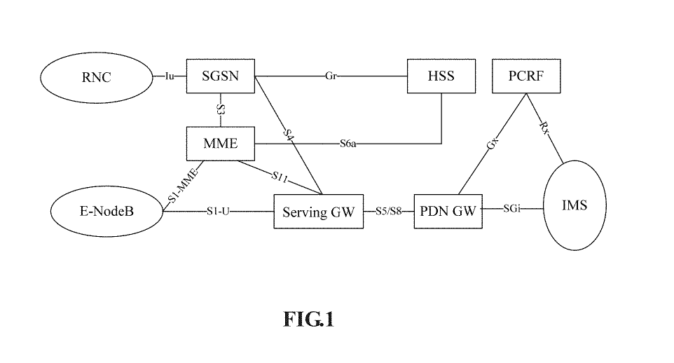

FIG. 2 is a diagram of architecture of a service network according to an embodiment herein.

FIG. 3 is a diagram of architecture in a 4G mobile network according to an embodiment herein.

FIG. 4 is a flowchart of accessing a service network according to an embodiment herein.

FIG. 5 is a flowchart of accessing a service network according to an embodiment herein.

FIG. 6 is a flowchart of accessing a service network according to an embodiment herein.

FIG. 7 is a flowchart of accessing a service network according to an embodiment herein.

FIG. 8 is a flowchart of accessing a service network according to an embodiment herein.

FIG. 9 is a flowchart of accessing a service network according to an embodiment herein.

FIG. 10 is a diagram of a device for accessing a service network according to an embodiment herein.

### DETAILED DESCRIPTION

Embodiments herein are elaborated below with reference to the drawings. Embodiments herein and features thereof may be combined with each other as long as no conflict results from the combination.

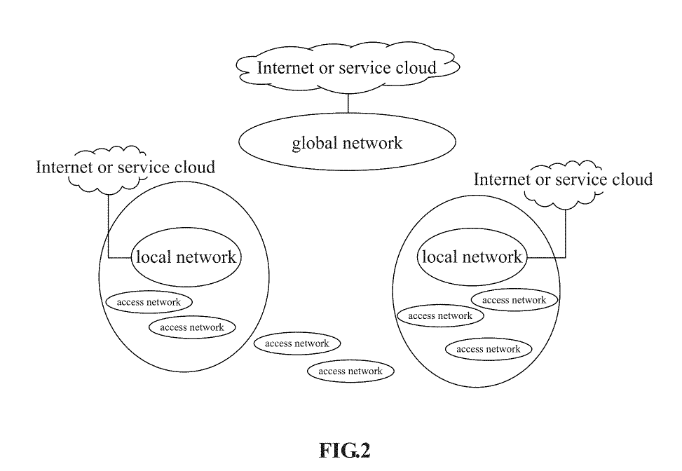

FIG. 2 is a diagram of architecture of a service network according to an embodiment herein. As shown in FIG. 2, a service network may be a local network or a global network.

A local network and a global network may be deployed independent of each other. A local network may be geographically closer to an access network to cover a specific area. A global network may cover a wider area, and may be constructed and operated in a localized manner.

A local network may relate to one or more visible physical entities, one or more software functionalities run in a physical equipment entity that are implemented by virtualization, or a software functionality run in a physical entity of access equipment (such as an eNB).

A global network may relate to one or more visible physical entities, one or more software functionalities run in a physical equipment entity that are implemented by virtualization, or a software functionality run in a physical entity of service cloud.

The service network may be a CN under architecture of a 2G, 3G, 4G mobile network, or functionality in a next-generation network that provides a network connection service to UE.

One physical location may be covered simultaneously by both a local network and a global network. At an initial access by UE, an access network may select a local network or a global network for the UE according a selectable policy or a policy designated by an operator. The UE may access the selected local or global network. The policy may include at least one of: an attribute of the UE, a service requested by the UE, a load of a service network, and a status of the service network. The attribute of the UE may include at least one of: UE of Internet of Things, UE of Internet of Vehicles, UE for industrial control, telemedicine UE, and UE of low mobility. The service requested by the UE may include at least one of: a mobile-Internet service, a Virtual Private Network (VPN) service, a service of Internet of Things, a service of Internet of Vehicles, an industrial-control service, a telemedicine service, a voice service, etc.

UE movement in a local network or a global network may follow a related service flow.

When idle UE moves out of an area covered by a serving BS (eNodeB), into an area covered by another BS, it may be prioritized that the idle UE accesses a service network of a type identical to that of a service network previously accessed by the idle UE. When there is no service network of the type or the service network of the type is unavailable, a service network may be re-selected for the idle UE.

A service network may be re-selected as follows. The UE may be notified by the network to get detached and then reattach to another network. Another network may be re-selected during update of a tracking area, by having, according to a list of tracking areas, the UE automatically send a request to update the tracking area when moving out of coverage of the local/global network.

The access network may acquire the attribute of the UE, the service requested by the UE, another policy factor, etc., in access signaling sent by the UE. The access network may acquire the load of a service network and the status of the service network by end-to-end detection. A service network may notify the access network of the load and the status of the service network.

With the method according to an embodiment herein, service networks may be deployed hierarchically, and a service network may be selected according to a policy of the access network, improving service experience of a subscriber, reducing pressure associated with localized deployment of a service network.

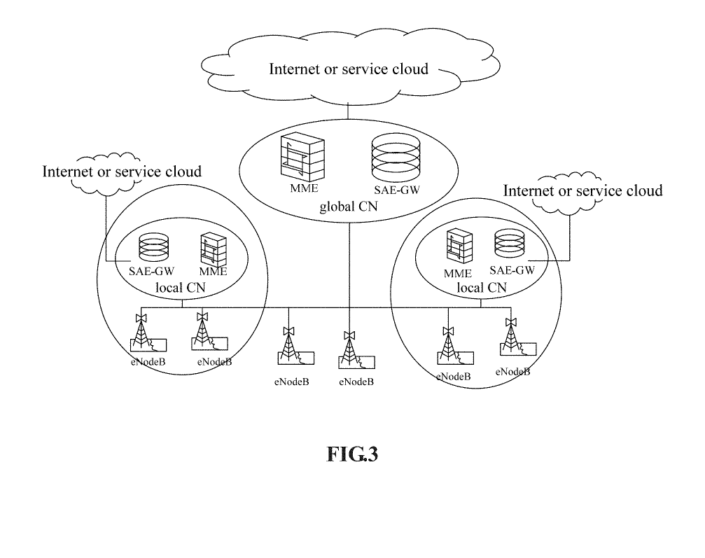

FIG. 3 shows architecture in a 4G mobile network according to an embodiment herein.

An EPC network may be deployed hierarchically according to characteristics and a requirement of a service. A local CN may be deployed in a certain area, such as a crowded area (e.g., a campus, a stadium, etc.), or an area with a dense collection of equipment of Internet of Things (e.g., a factory, a community, etc.). Meanwhile, the area covered by the local CN may be covered simultaneously by a global CN constructed by an operator in a localized manner. An eNB in the area may be connected to both the local CN and the global CN. A subscriber may attempt access from an eNB in a certain area. The eNB may determine, according to a policy, whether to admit the subscriber into a local CN or the global CN. The policy may include at least one of: an attribute of the UE, a service requested by the UE, a load of a service network, and a status of the service network. The attribute of the UE may include at least one of: UE of Internet of Things, UE of Internet of Vehicles, UE for industrial control, telemedicine UE, and UE of low mobility. The service requested by the UE may include at least one of: a mobile-Internet service, a Virtual Private Network (VPN) service, a service of Internet of Things, a service of Internet of Vehicles, an industrial-control service, a telemedicine service, a voice service, etc.

UE of Internet of Things may be prioritized to be admitted into a local CN.

UE of Internet of Vehicles may be prioritized to be admitted into the global CN.

UE of low mobility may be prioritized to be admitted into a local CN.

UE of none of the above may be prioritized to be admitted into the global CN.

UE requesting a VPN service may be prioritized to be admitted into a CN connected to a VPN.

UE requesting a voice service may be prioritized to be admitted into the global CN.

UE of none of the above may be prioritized to be admitted into the global CN.

UE may be admitted into the global CN when a local network is heavily loaded or unavailable.

UE may be admitted into a local CN when the global network is heavily loaded or unavailable.

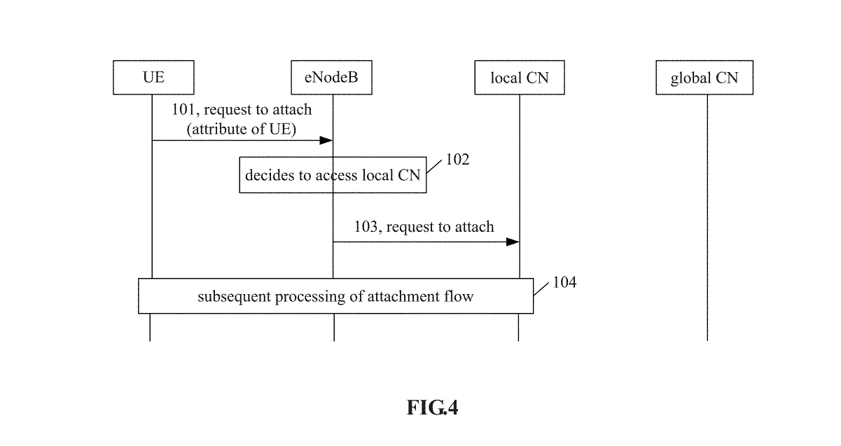

As shown in FIG. 4, according to an embodiment herein (with architecture of a 4G network as an example), an eNB may choose to admit UE into a local CN according to an attribute of the UE.

In step S101, UE, covered by an eNB connected to both a local CN and a global CN, may initiate a request to attach. The request to attach may include an attribute of the UE.

In step S102, the eNB may decide to admit the UE into the local CN according to the attribute of the UE.

In step S103, the eNB may forward, to the local CN, the request to attach sent by the UE.

In step S104, the local CN may admit a subscriber of the UE according to a 4G attachment flow.

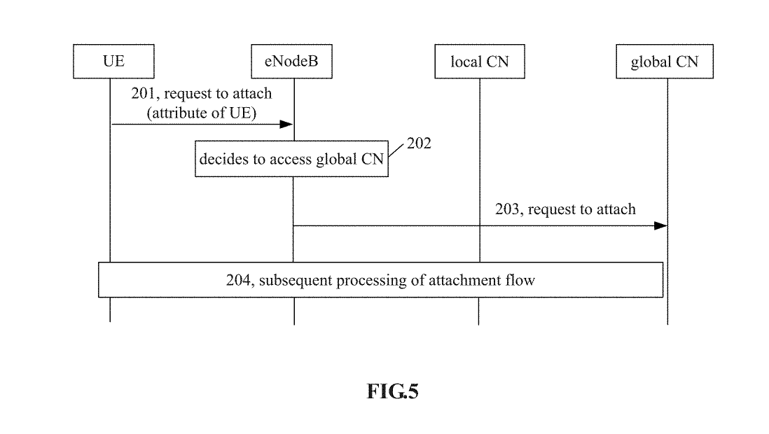

As shown in FIG. 5, according to an embodiment herein (with architecture of a 4G network as an example), an eNB may choose to admit UE into a global CN according to an attribute of the UE.

In step S201, UE, covered by an eNB connected to both a local CN and a global CN, may initiate a request to attach. The request to attach may include an attribute of the UE.

In step S202, the eNB may decide to admit the UE into the global CN according to the attribute of the UE.

In step S203, the eNB may forward, to the global CN, the request to attach sent by the UE.

In step S204, the global CN may admit a subscriber of the UE according to a 4G attachment flow.

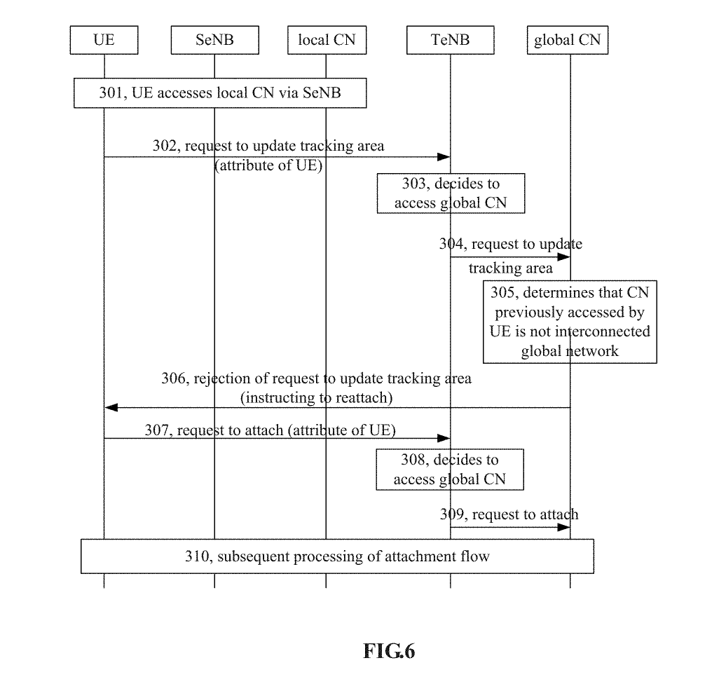

As shown in FIG. 6, according to an embodiment herein (with architecture of a 4G network as an example), when idle UE moves, a network side may re-select a service network for the idle UE by reattachment, switching the idle UE from a local CN to a global CN.

In step S301, UE may access a Source eNodeB (SeNB) and establish a connection with a local CN. The UE may be in an idle status.

In step S302, the idle UE may move into an area covered by a Target eNodeB (TeNB). The TeNB may be connected but to a global CN. The idle UE may initiate a request to update a tracking area including an attribute of the idle UE.

In step S303, the TeNB may find, according to the attribute of the idle UE, that prioritized access of the local CN is unavailable, and may decide to admit the idle UE into the global CN.

In step S304, the TeNB may send, to the global CN, a request to update the tracking area.

In step S305, the global CN may determine that a CN previously accessed by the idle UE is not an interconnected global network, and that communication with the CN previously accessed by the idle UE is unavailable.

In step S306, the global CN may return, to the idle UE, a rejection of the request to update the tracking area, instructing the idle UE to reattach.

In step S307, the idle UE may further initiate a request to attach. The request to attach may include the attribute of the idle UE.

In step S308, the TeNB may decide to admit the idle UE into the global CN.

In step S309, the TeNB may forward, to the global CN, the request to attach.

In step S310, the global CN may admit a subscriber of the UE according to a 4G attachment flow.

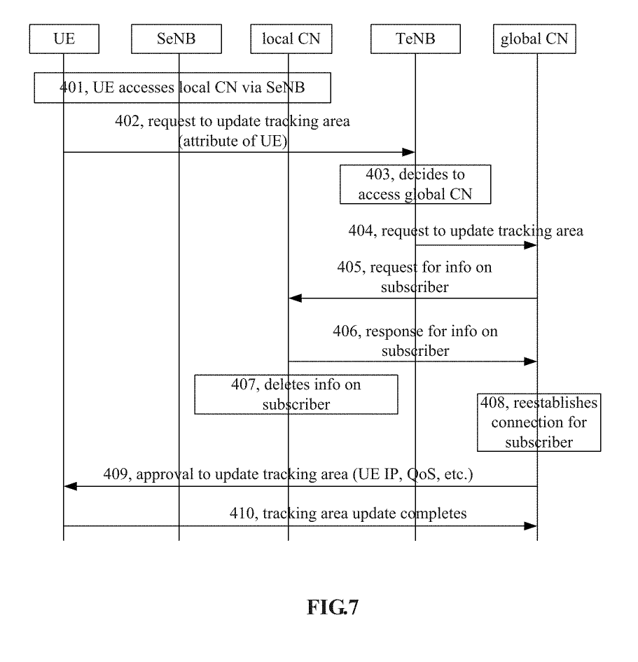

As shown in FIG. 7, according to an embodiment herein (with architecture of a 4G network as an example), when idle UE moves, a network side may re-select a service network for the idle UE during update of a tracking area, switching the idle UE from a local CN to a global CN.

In step S401, UE may access a SeNB and establish a connection with a local CN. The UE may be in an idle status.

In step S402, the idle UE may move into an area covered by a TeNB. The TeNB may be connected but to a global CN. The idle UE may initiate a request to update a tracking area including an attribute of the idle UE.

In step S403, the TeNB may find, according to the attribute of the idle UE, that prioritized access of the local CN is unavailable, and may decide to admit the idle UE into the global CN.

In step S404, the TeNB may send, to the global CN, a request to update the tracking area.

In step S405, the global CN may acquire, from the local CN, information on a subscriber of the idle UE.

In step S406, the local CN may send, to the global CN, the information on the subscriber.

In step S407, the local CN may delete the information on the subscriber in a local network. The information on the subscriber may include context associated with mobility management, bearer context of the subscriber, etc.

In step S408, the global CN may reconstruct, for the subscriber, context associated with mobility management. The global CN may reconstruct, for the subscriber, bearer context.

In step S409, the global CN may return, to the subscriber, an approval to update the tracking area. The approval to update the tracking area may include bearer information reconstructed for the subscriber, such as an IP address of the subscriber, QoS, etc.

In step S410, the UE may return a message indicating that tracking area update completes.

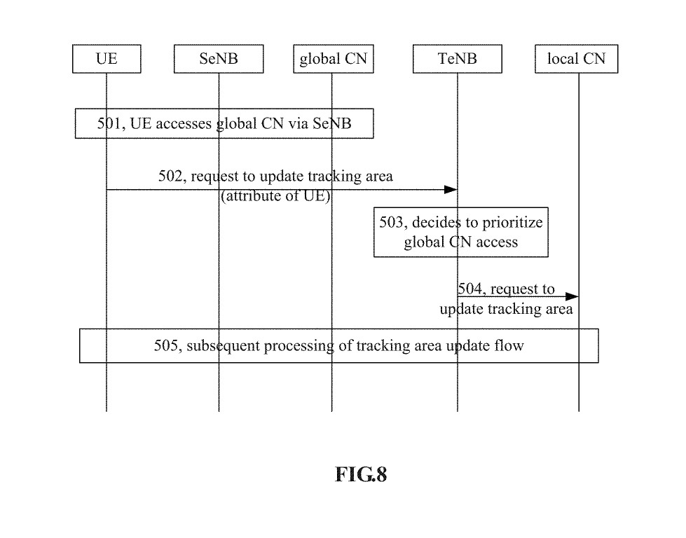

As shown in FIG. 8, according to an embodiment herein (with architecture of a 4G network as an example), when idle UE moves, a service network previously accessed by the idle UE may be preferably selected for a subscriber of the idle UE.

In step S501, UE may access a SeNB and establish a connection with a global CN. The UE may be in an idle status.

In step S502, the idle UE may move into an area covered by a TeNB. The TeNB may be connected to both the global CN and a local CN. The idle UE may initiate a request to update a tracking area including an attribute of the idle UE.

In step S503, the TeNB may prioritize, according to the attribute of the idle UE and information on a network previously accessed by the idle UE, access of the global CN by the idle UE.

In step S504, the TeNB may send, to the global CN, a request to update the tracking area.

In step S505, the global CN may admit a subscriber of the idle UE according to a 4G tracking area update flow.

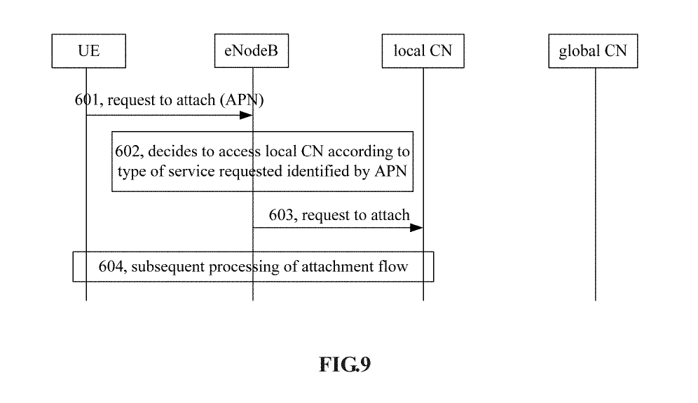

As shown in FIG. 9, according to an embodiment herein (with architecture of a 4G network as an example), the eNB uses the policy of a service requested by the UE to select the local CN for the UE to access.

In step S601, UE, covered by an eNB connected to both a local CN and a global CN, may initiate a request to attach. The request to attach may include an Access Point Name (APN).

In step S602, the eNB may decide to admit the UE into the local CN according to a type of a service requested by the UE as indicated by the APN.

In step S603, the eNB may forward, to the local CN, the request to attach sent by the UE.

In step S204, the local CN may admit a subscriber of the UE according to a 4G attachment flow.

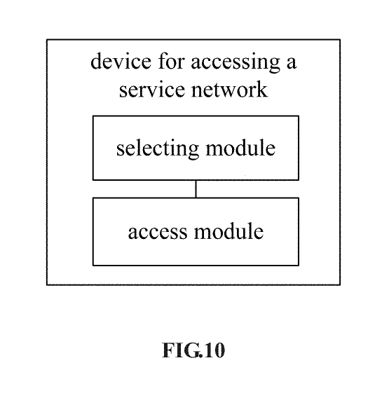

FIG. 10 is a diagram of a device for accessing a service network according to an embodiment herein. As shown in FIG. 10, the device includes a selecting module and an access module.

The selecting module is arranged for at an initial access by UE, selecting, for the UE according a policy, a service network. The service network includes at least one of a local network and a global network.

The access module is arranged for: allowing the UE to access the selected service network.

The policy may be an attribute of the UE, a service requested by the UE, a load of a service network, a status of the service network, etc.

The attribute of the UE may be UE of Internet of Things, UE of Internet of Vehicles, UE for industrial control, telemedicine UE, UE of low mobility, etc.

The service requested by the UE may be a mobile-Internet service, a Virtual Private Network (VPN) service, a service of Internet of Things, a service of Internet of Vehicles, an industrial-control service, a telemedicine service, a voice service, etc.

The selecting module may be further arranged for: in response to determining that idle UE moves out of an area covered by a serving Base Station (BS), into an area covered by another BS, allowing the idle UE to access a service network of a type identical to that of a service network previously accessed by the idle UE; in response to determining that there is no service network of the type or the service network of the type is unavailable, re-selecting a service network for the idle UE.

The selecting module may be arranged for re-selecting the service network for the idle UE by notifying the idle UE to get detached and then reattach to the re-selected service network.

The selecting module may be arranged for re-selecting the service network for the idle UE during update of a tracking area.

A BS according to an embodiment herein includes an aforementioned device for accessing a service network.

A computer-readable storage medium according to an embodiment herein has stored therein computer-executable instructions for performing an aforementioned method for accessing a service network.

Those skilled in the art may understand that all or part of the steps of the method may be completed by instructing a related hardware through a program. The program may be stored in a transitory or non-transitory computer-readable storage medium. The computer-readable storage medium may be Read-Only Memory (ROM), a magnetic disk, a CD, and/or the like. All or part of the steps in an aforementioned embodiment may be implemented using one or more Integrated Circuits. A unit or module in an aforementioned embodiment may be implemented in form of hardware or a software functional module. The present disclosure is not limited to any specific combination of hardware and software.

What disclosed are merely embodiments herein. The disclosure may have other embodiments. Those skilled in the art may make various modifications and variations to the present disclosure without departing from the spirit and essence of the present disclosure. Such modifications and variations shall fall within the scope of the claims.

### INDUSTRIAL APPLICABILITY

An aforementioned technical solution implements hierarchical deployment of service networks, thereby reducing a delay of a subscriber.

What is claimed is:

1. A method for accessing a service network, comprising:
at an initial access by UE, selecting, for the UE according a policy, a service network, wherein the service network comprises at least one of a local network and a global network; and
allowing the UE to access the selected service network.

2. The method according to claim 1,
wherein the policy comprises at least one of: an attribute of the UE, a service requested by the UE, a load of a service network, and a status of the service network,
wherein the attribute of the UE comprises at least one of: UE of Internet of Things, UE of Internet of Vehicles, UE for industrial control, telemedicine UE, and UE of low mobility,
wherein the service requested by the UE comprises at least one of: a mobile-Internet service, a Virtual Private Network (VPN) service, a service of Internet of Things, a service of Internet of Vehicles, an industrial-control service, a telemedicine service, and a voice service.

3. The method according to claim 1, further comprising:
in response to determining that idle UE moves out of an area covered by a serving Base Station (BS), into an area covered by another BS, allowing the idle UE to access a service network of a type identical to that of a service network previously accessed by the idle UE; in response to determining that there is no service network of the type or the service network of the type is unavailable, re-selecting a service network for the idle UE.

4. The method according to claim 3, wherein the re-selecting a service network for the idle UE comprises:
notifying the idle UE to get detached and then reattach to the re-selected service network.

5. The method according to claim 3, wherein the re-selecting a service network for the idle UE comprises:
re-selecting the service network for the idle UE during update of a tracking area.

6. A device for accessing a service network, comprising:
a selecting module arranged for: at an initial access by UE, selecting, for the UE according a policy, a service network, wherein the service network comprises at least one of a local network and a global network; and
an access module arranged for: allowing the UE to access the selected service network.

7. The device according to claim 6,
wherein the policy comprises at least one of: an attribute of the UE, a service requested by the UE, a load of a service network, and a status of the service network,
wherein the attribute of the UE comprises at least one of: UE of Internet of Things, UE of Internet of Vehicles, UE for industrial control, telemedicine UE, and UE of low mobility,
wherein the service requested by the UE comprises at least one of: a mobile-Internet service, a Virtual Private Network (VPN) service, a service of Internet of Things, a service of Internet of Vehicles, an industrial-control service, a telemedicine service, and a voice service.

8. The device according to claim 6,
wherein the selecting module is further arranged for: in response to determining that idle UE moves out of an area covered by a serving Base Station (BS), into an area covered by another BS, allowing the idle UE to access a service network of a type identical to that of a service network previously accessed by the idle UE; in response to determining that there is no service network of the type or the service network of the type is unavailable, re-selecting a service network for the idle UE.

9. The device according to claim 8, wherein the selecting module is arranged for re-selecting the service network for the idle UE by
notifying the idle UE to get detached and then reattach to the re-selected service network.

10. The device according to claim 8, wherein the selecting module is arranged for re-selecting the service network for the idle UE by
re-selecting the service network for the idle UE during update of a tracking area.

11. A Base Station (BS), comprising the device according to claim 6.

12. A computer-readable storage medium having stored therein computer-executable instructions for performing a method for accessing a service network, the method comprising:
at an initial access by UE, selecting, for the UE according a policy, a service network, wherein the service network comprises at least one of a local network and a global network; and
allowing the UE to access the selected service network.

13. The storage medium according to claim 12,
wherein the policy comprises at least one of: an attribute of the UE, a service requested by the UE, a load of a service network, and a status of the service network,
wherein the attribute of the UE comprises at least one of: UE of Internet of Things, UE of Internet of Vehicles, UE for industrial control, telemedicine UE, and UE of low mobility,
wherein the service requested by the UE comprises at least one of: a mobile-Internet service, a Virtual Private Network (VPN) service, a service of Internet of Things, a service of Internet of Vehicles, an industrial-control service, a telemedicine service, and a voice service.

14. The storage medium according to claim 12, wherein the method further comprises:
in response to determining that idle UE moves out of an area covered by a serving Base Station (BS), into an area covered by another BS, allowing the idle UE to access a service network of a type identical to that of a service network previously accessed by the idle UE; in response to determining that there is no service network of the type or the service network of the type is unavailable, re-selecting a service network for the idle UE.

15. The storage medium according to claim 14, wherein the re-selecting a service network for the idle UE comprises:
notifying the idle UE to get detached and then reattach to the re-selected service network.

16. The storage medium according to claim 14, wherein the re-selecting a service network for the idle UE comprises:
re-selecting the service network for the idle UE during update of a tracking area.

17. The BS according to claim 11,
wherein the policy comprises at least one of: an attribute of the UE, a service requested by the UE, a load of a service network, and a status of the service network,
wherein the attribute of the UE comprises at least one of: UE of Internet of Things, UE of Internet of Vehicles, UE for industrial control, telemedicine UE, and UE of low mobility,
wherein the service requested by the UE comprises at least one of: a mobile-Internet service, a Virtual Private Network (VPN) service, a service of Internet of Things, a service of Internet of Vehicles, an industrial-control service, a telemedicine service, and a voice service.

18. The BS according to claim 11,
wherein the selecting module is further arranged for: in response to determining that idle UE moves out of an area covered by a serving Base Station (BS), into an area covered by another BS, allowing the idle UE to access a service network of a type identical to that of a service network previously accessed by the idle UE; in response to determining that there is no service network of the type or the service network of the type is unavailable, re-selecting a service network for the idle UE.

19. The BS according to claim 18, wherein the selecting module is arranged for re-selecting the service network for the idle UE by
notifying the idle UE to get detached and then reattach to the re-selected service network.

20. The BS according to claim 18, wherein the selecting module is arranged for re-selecting the service network for the idle UE by
re-selecting the service network for the idle UE during update of a tracking area.
